(19) United States
(12) Patent Application Publication
(10) Pub. No.: US 2020/0386554 A1
(43) Pub. Date: Dec. 10, 2020

(54) COMPACT MAP BASED ON PARENT-CHILD RELATION

(71) Applicant: GM Global Technology Operations LLC, Detroit, MI (US)

(72) Inventors: Qingqing Zhou, Ontario (CA); Rakesh Kumar, Ontario (CA)

(21) Appl. No.: 16/436,266

(22) Filed: Jun. 10, 2019

(51) Int. Cl. G01C 21/28; G06F 16/29; G01S 19/42

(52) U.S. Cl. CPC G01C 21/28; G01S 19/42; G06F 16/29

(57) ABSTRACT

A method to produce data of a series of location coordinates of a motor vehicle includes one or more of the following: receiving a location point on a map of the motor vehicle, each location being treated as a child with a specific character; grouping multiple children who reside in a common area, the grouping sharing a same parent; and identifying the parent as a common zone factor, wherein the common zone factor is a constant value common to all location points of a particular zone.

### INTRODUCTION

The present disclosure relates to a data format to represent location coordinates for a motor vehicle. More specifically, the present disclosure relates to a compact map based on parent-child relations for a motor vehicle.

In many motor vehicles, the motor vehicle is equipped with a navigation system, or an occupant of the motor vehicle has a portable navigation application on a mobile device to determine the location of the motor vehicle on a map. The database for the map, especially a high definition map, typically includes a multitude of location coordinates, such as latitude and longitude.

The databases for these maps, however, require a tremendous amount of memory. Thus, while current databases for maps achieve their intended purpose, there is a need for a new and improved system and process to generate and store location coordinates to reduce the map data size.

### SUMMARY

According to several aspects, a method to produce data of a series of location coordinates of a motor vehicle includes one or more of the following: receiving a location point on a map of the motor vehicle, each location being treated as a child with a specific character; grouping multiple children who reside in a common area, the grouping sharing a same parent; and identifying the parent as a common zone factor, wherein the common zone factor is a constant value common to all location points of a particular zone.

In an additional aspect of the present disclosure, the location point has latitude and longitude coordinates.

In another aspect of the present disclosure, identifying the common zone factor compresses the data.

In another aspect of the present disclosure, the compression of the data reduces storage requirements of the data.

In another aspect of the present disclosure, the reduction of the storage requirement is about 60% less than the storage requirement without the compression of the data.

In another aspect of the present disclosure, a first set of digits of multiple digits of the coordinates determines an outer zone.

In another aspect of the present disclosure, a second set of digits of the multiple digits determines an inner zone.

In another aspect of the present disclosure, a remaining set of digits of the multiple digits is converted to Cartesian coordinates of the location points.

According to several aspects, a system to produce data of a series of location coordinates of a motor vehicle includes a controller that receives a location point on a map of the motor vehicle, each location being treated as a child with a specific character, the controller implemented with an algorithm that groups multiple children who reside in a common area, the grouping sharing a same parent, and identifies the parent as a common zone factor, wherein the common zone factor is a constant value common to all location points of a particular zone.

In another aspect of the present disclosure, the location point is obtained from over the air database.

In another aspect of the present disclosure, the location point has latitude and longitude coordinates.

In another aspect of the present disclosure, identifying the common zone factor compresses the data.

In another aspect of the present disclosure, a first set of digits of multiple digits of the coordinates determines an outer zone.

In another aspect of the present disclosure, a second set of digits of the multiple digits determines an inner zone.

In another aspect of the present disclosure, a remaining set of digits multiple digits is converted to Cartesian coordinates.

According to several aspects, a method to produce data of a series of location coordinates of a motor vehicle includes one or more of the following: receiving a location point on a map of the motor vehicle, each location having a latitude and a longitude coordinate, each location being treated as a child with a specific character; grouping multiple children who reside in a common area, the grouping sharing a same parent; identifying the parent as a common zone factor, wherein the common zone factor is a constant value common to all location points of a particular zone; and calculating multiple digits from the location points in the common zone, a first set of digits of the multiple digits determining an outer zone; a second set of digits of the multiple digits determining an inner zone, and a remaining set of digits of the multiple digits is converted to Cartesian coordinates of the location points.

In another aspect of the present disclosure, identifying the common zone factor compresses the data to reduce storage requirements of the data by about 60% as compared to the storage requirement without the compression of the data.

In another aspect of the present disclosure, the parent-child format is compresses the location data without jeopardizing the accuracy of the original location points.

In another aspect of the present disclosure, the flexibility of choosing a range for the common zone and the number of outer and inner zones provide different applications with arbitrary accuracies and storage requirements.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a block diagram of a process to generate a compact map in accordance with the present disclosure;

FIG. 2 is a block diagram of a vehicle in which the process shown in FIG. 1 is implemented in accordance with the present disclosure;

FIG. 3 is an example of a map that provides data for the process shown in FIG. 1 in accordance with the present disclosure;

FIG. 4A is a zone of the map shown in FIG. 3 in accordance with the present disclosure;

FIG. 4B is a table of Cartesian coordinates generated from the zone in FIG. 4A in accordance with the present disclosure;

FIG. 5 is an x/y graph of a Cartesian coordinate in accordance with the present disclosure;

FIGS. 6A and 6B show results of converted data in accordance with the present disclosure; and

FIG. 7 shows a table the extent of compression of map data in accordance with the present disclosure;

FIG. 8A shows a Geohash-to-Cartesian lookup table; and

FIG. 8B shows a 12 bits-Cartesian Coefficient lookup table.

### DETAILED DESCRIPTION

The following description is merely exemplary in nature and is not intended to limit the present disclosure, application, or uses.

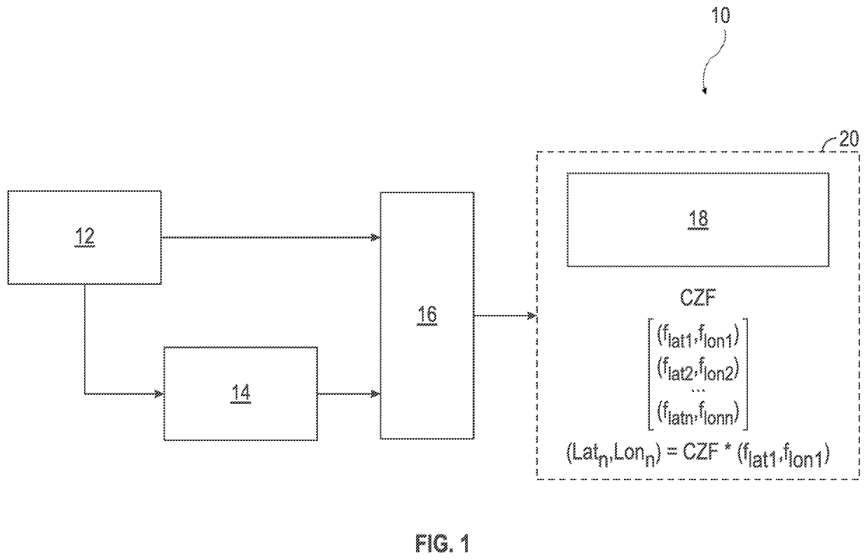

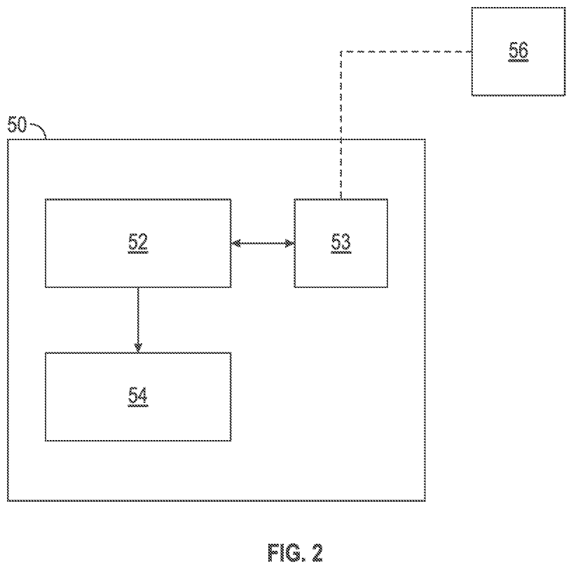

Referring to FIG. 1, there is shown a process 10 that compacts map data according to parent-child relations. The process 10 includes a block 20 with a compressed database 18. The compressed database 18 is generated by a parent-child format generator in block 16. The block 16 contains a piece of software running the conversion and compression algorithm. Block 16 receives data from either a master database 12 or an over-the-air (OTA) database 14, for example, such as latitude and longitude data based on GPS. The block 16 runs as a map database pre-process on the cloud and generates in-vehicle compressed database to be downloaded into the vehicle electronic module, such as, for example, a controller 52 (FIG. 2). The compressed database 18 receives data from either the master database 12 or the OTA database 14 that is generated by the master database 12.

The block 20, in some arrangements, is implemented in the controller 52 of a motor vehicle 50, as shown in FIG. 2. A transmitter/transceiver 53 receives a compressed database from a block 56, which can be either a cloud-based server or a local host machine via a wired or wireless communication interface.

Accordingly, location points conversion and compression occur on either a cloud-based backend server or a single computer processor instead of inside any controller in the vehicle. As such, the map database is pre-processed, including compressing and extracting common features, significantly before sending this database to the motor vehicle. Hence, the process 10 reduces the storage requirements for an in-vehicle electronic module and eliminates the conversion process from an in-vehicle electronic module since it can be accomplished during the map database pre-processing state.

The controller 52 which is a non-generalized, electronic control device having a preprogrammed digital computer or processor, memory or non-transitory computer readable medium used to store data such as control logic, software applications, instructions, computer code, data, lookup tables, etc., and a transceiver (or input/output ports). Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 10 is configured to execute the code or instructions. Where the controller 52 is an infotainment control module that communicates with an interface 54 that enables an occupant of the motor vehicle to interact with infotainment control module.

The controller 52 further includes one or more applications, such as, a software program configured to perform a specific function or set of functions. The applications may include one or more computer programs, software components, sets of instructions, procedures, functions, objects, classes, instances, related data, or a portion thereof adapted for implementation in a suitable computer readable program code. The applications may be stored within the memory or in additional or separate memory.

In various arrangements, the block 20 receives latitude and longitude coordinates (fₗₐₜ₁,fₗₒₙ₁) . . . (fₗₐₜₙ,fₗₒₙₙ) from the master database 18 or the OTA database 14. All the location points in the OTA database 14 are treated as children with different characteristics. More specifically, each child dataset is associated with a common zone factor (CZF), where the CZF is a constant value (factor) common to all points in a particular zone. The block 20 then applies the CZF to the latitude and longitude coordinates (fₗₐₜ₁,fₗₒₙ₁) . . . (fₗₐₜₙ,fₗₒₙₙ) and generates compact parent-child format coordinates from the relation (Latₙ,Lonₙ)=CZF*(fₗₐₜ₁,fₗₒₙ₁).

The typical size of CZF is 2 Bytes, and the memory reduction is by a factor 2*2*n, where n is the number of points in the zone. Results from the process 10 provides a reduction in memory requirements by more than about 60% without compromising the accuracy of the map data. Note that the higher the density of the points, the higher the reduction in memory requirements.

Hence, the process 10 provides a unique data format to represent a series of location coordinates such as the latitude and longitude in a high definition map, while reducing the storage requirements at the same time, based on a parent-child relationship. Each location point that the map uses to represent, for example, a road edge or a road sign location is treated as a child with its specific character. And a group of children who resides in a common area will share the same parent referred to as the common zone factor (CZF).

If this format is utilized to store the map into a database, the data is stored as a parent and its children instead of non-related latitude and longitude coordinates. This database with the parent-child relationship enables an efficient searching mechanism because the data relationship has been pre-processed when creating the in-vehicle map database. When the vehicle gets the current location while driving, the same mechanism is utilized to find the parent also known as the common zone factor of the current location and grab all the children who are under the same parent from the database. Since the parent-child relationship can also be expressed as a grandparent, parent and child or great-grand-parent, this format provides an arbitrary level of relationship so that can be flexibly implemented based on the accuracy, data complexity and required common zone size, which can also be utilized for map comparisons.

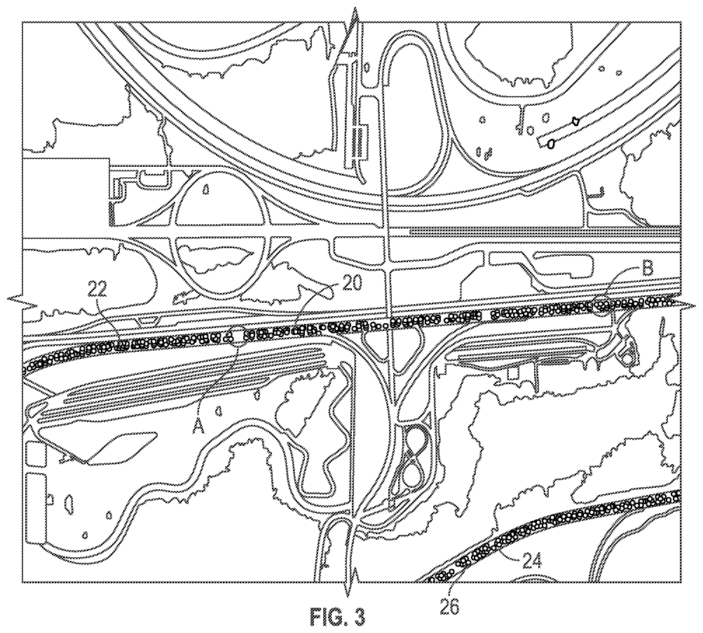

Turning now to FIG. 3, there is shown a map in which the process 10 is utilized to compress the map data based on parent-child relations. The map shows two roads 20 and 24 with locations points 22 and 26, respectively. Moving from point A to point B, only the least 4 or 5 digits of the latitude and longitude are changing, while the rest of the more significant digits do not change. Therefore, the goal is to find the common factor and extract it from all the points that share the same factor.

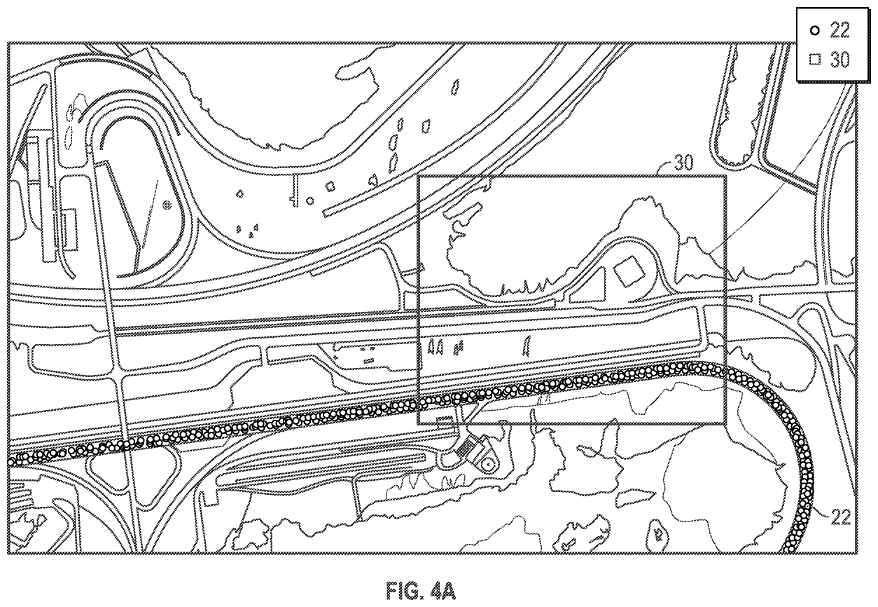

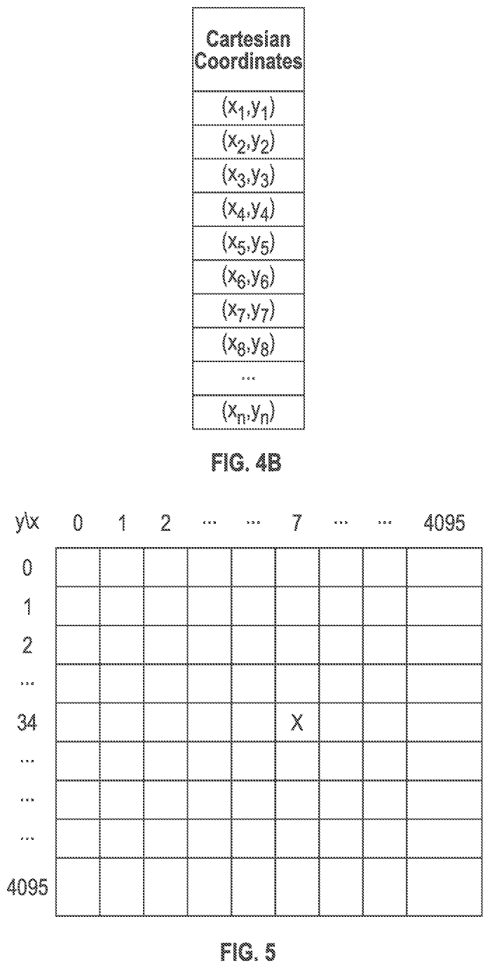

Accordingly, the process 10 selects a parent, which in this case is in a zone 30, that provides a CZF valve. All the points that belong to this common zone are extracted. A conversion calculation is performed to get a list of (x, y) local Cartesian coordinates (FIG. 4B). Additionally, a local Cartesian map is provided, which is helpful for sensor fusion since most of the sensor outputs are with regard to vehicle center based local Cartesian coordinates.

More specifically, to ensure that relational location data meets the high definition map and localization requirements, common zones can be defined as outer and inner zones. Each zone is represented by three digits of the GeoHash value of a location point. (A zone can be defined with different number of digits of the GeoHash for arbitrary accuracy.)

As an example, a 11-digits GeoHash value is calculated from latitude and longitude locations points. The first three digits identify an outer zone, for example, 156 km by 156 km. The second three digits identify an inner zone, for example, 1.22 km by 0.61 km. And the remaining five digits are utilized to convert to Cartesian coordinates.

In this example, the local Cartesian coordinates of the inner zone includes a multitude of 4096 by 4096 grids (FIG. 5). (Arbitrary unit value within the inner can be achieved by adjusting the Cartesian grids.) A rational coordinates formula acquires (x,y) coordinates, in which each grid is 14.9 cm by 29.8 cm with a maximum error of 16 cm to get the same accuracy as presented by the original latitude and longitude. The grid size of the grid shown in FIG. 5 in the local Cartesian system is adjusted based on precision requirements. The combination of the parent zone's width and height and the number of grids defines the conversion formula, data size and precision.

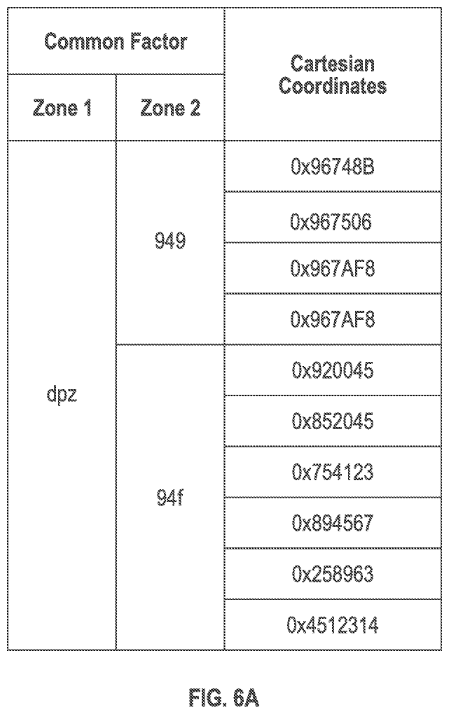

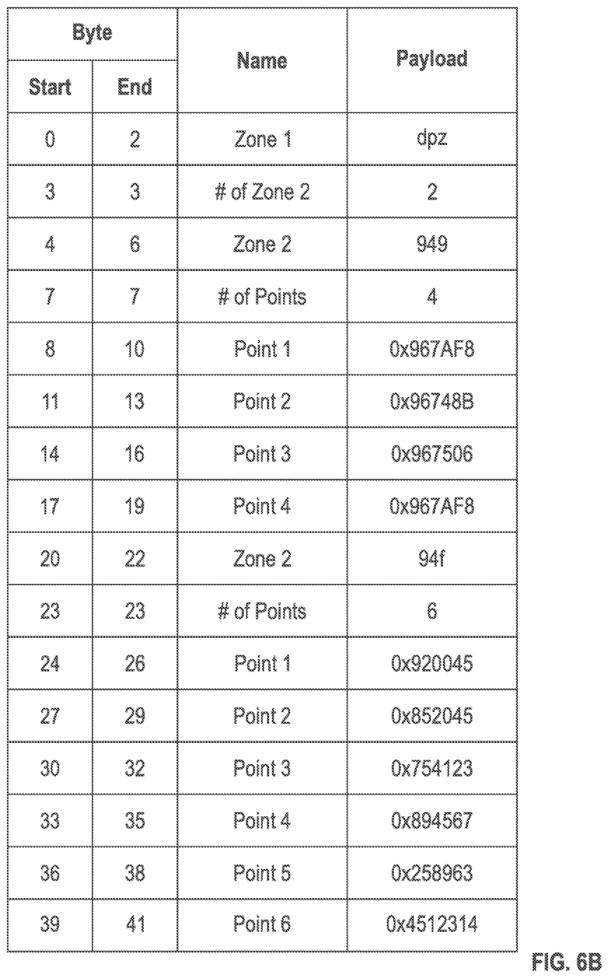

FIGS. 6A and 6B show the final result of the converted data utilizing process described above. The table in FIG. 6A shows one of the possible ways to store the data into the database, and FIG. 6B shows another way to store the series of data into a blob for non-relationship database or for transmission over the air.

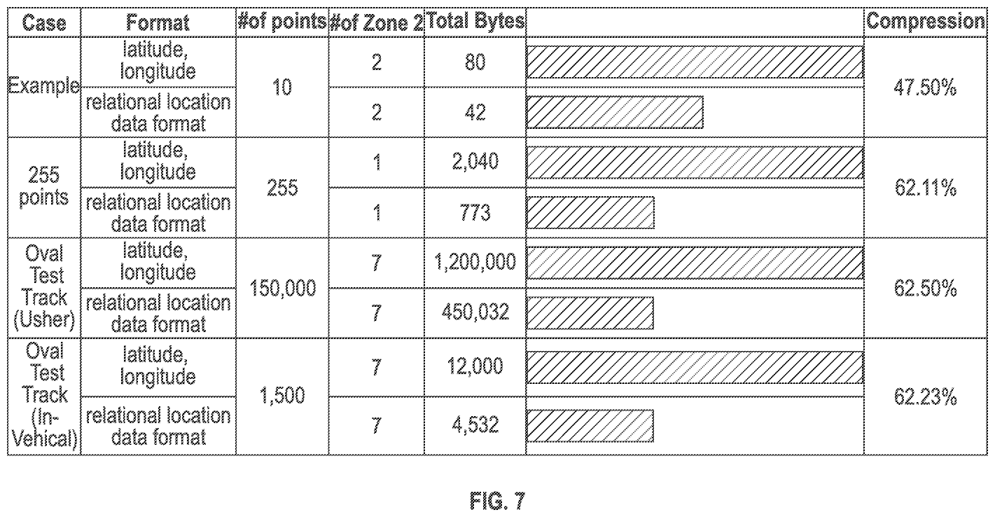

Accordingly, the example described above shows that random location data points of a road can be compressed for in-vehicle data (FIG. 7). Regardless if the dataset is high density or has been compressed previously, the process 10 can always apply the parent-child format for further compression. Further, because of the format of the process 10, the shape of the road does not matter. Moreover, the parent-child format compression is based on extracting a common zone factor rather than removing the data points from the map. Therefore, this format is utilized to generate compressed maps without losing data points from the map.

Shown below are the formulas that are employed to perform the conversion from GeoHash to Cartesian in parent-child format:

$[ \begin{matrix}x \\ y\end{matrix} ] = [ \begin{matrix}{\sum }_{i = 7}^{11} {Val}_{x} ( {d}_{i} ) \times {Coe}_{x} ( i ) \\ {\sum }_{i = 7}^{11} {Val}_{y} ( {d}_{i} ) \times {Coe}_{y} ( i )\end{matrix} ]$

| | |
|---|---|
| (x, y) | denotes the 12 bits cartesian coordinate |
| dᵢ | denotes the i-th letter in the 11 digits Geohash |
| Valₓ(dᵢ) | letter dᵢ’s x coordinate value from Geohash-Cartesian lookup table |
| Val_{y}(dᵢ) | letter dᵢ’s x coordinate value from Geohash-Cartesian lookup table |
| Coeₓ(i) | level i’s x coeffiecient value from 12 bits Cartesian Coefficient lookup table |
| Coe_{y}(i) | level i’s y coeffiecient value from 12 bits Cartesian Coefficient lookup table |

Shown below are the formulas that are employed to perform the conversion from Cartesian in parent-child format to GeoHash

$[ \begin{matrix}{GeoHash}_{x} [ i ] \\ {GeoHash}_{y} [ i ]\end{matrix} ] = [ \begin{matrix}\frac{x - {\sum }_{n = 7}^{i - 1} {GeoHash}_{x} [ n ] \times {Coe}_{x} ( n )}{{Coe}_{x} ( i )} \\ \frac{y - {\sum }_{n = 7}^{i - 1} {GeoHash}_{y} [ n ] \times {Coe}_{y} ( n )}{{Coe}_{y} ( i )}\end{matrix} ]$
dᵢ = Decode (GeoHashx[i], GeoHashy[i])
$GeoHash\_Val = Append ( zone 1 + zone 2 + {\sum }_{i = 7}^{11} {d}_{i} )$

| | |
|---|---|
| x, y | The 12 bits cartesian coordinates on x-axis and y-axis respectively |
| dᵢ | The i-th letter in the 11 digits Geohash |
| GeoHash_Val | The complete Geohash string/value |
| GeoHashₓ[i] | The x or y value of the i-th digit of Geohash string in the Geohash-to-Cartesian |
| GeoHash_{y}[i] | lookup table |
| Coeₓ(i) | The x or y coefficient value of the i-th digit in Geohash from 12 bits Cartesian |
| Coe_{y}( i) | Coefficient lookup table |
| Decode | The value of dᵢ by looking up (GeoHashₓ[i], GeoHash_{y}[i]) from Geohash-to- |
| | Cartesian lookup table |
| Append | Aggregate all the digits from zone1, zone2 and results of Decode() |

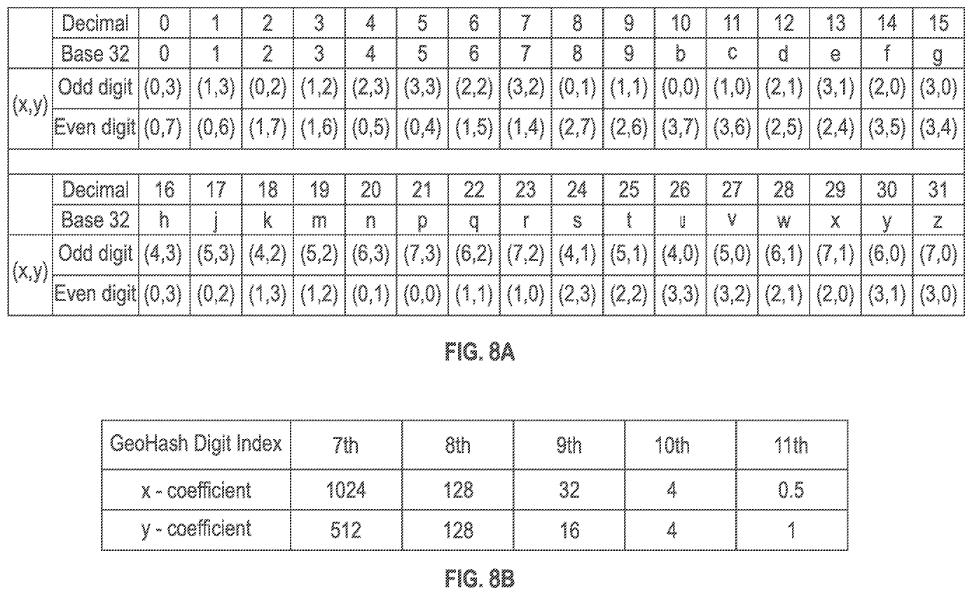

Shown in FIG. 8A is an example of a Geohash-to-Cartesian lookup table and shown in FIG. 8B is an example of a 12 bits-Cartesian coefficient lookup table utilized by the above formulas.

In summary, the algorithm in the process 10 provides a high quality map data set while employing less storage. The process 10 enables sending large high definition map data sets in real time by splitting the data into smaller common zone areas without compromising the precision of the data. Accordingly, the process 10 provides a low cost solution for high definition map storage in real time.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method to produce data of a series of location coordinates of a motor vehicle, the method comprising:
receiving a location point on a map of the motor vehicle, each location being treated as a child with a specific character;
grouping multiple children who reside in a common area, the grouping sharing a same parent; and
identifying the parent as a common zone factor, wherein the common zone factor is a constant value common to all location points of a particular zone.

2. The method of claim 1, wherein the location point has latitude and longitude coordinates.

3. The method of claim 1, wherein identifying the common zone factor compresses the data.

4. The method of claim 3, wherein the compression of the data reduces storage requirements of the data.

5. The method of claim 4, wherein the reduction of the storage requirement is about 60% less than the storage requirement without the compression of the data.

6. The method of claim 2, wherein a first set of digits of multiple digits of the coordinates determines an outer zone.

7. The method of claim 6, wherein a second set of digits of the multiple digits determines an inner zone.

8. The method of claim 7, wherein a remaining set of digits of the multiple digits is converted to Cartesian coordinates of the location points.

9. A system to produce data of a series of location coordinates of a motor vehicle, the system comprising:
a controller that receives a location point on a map of the motor vehicle, each location being treated as a child with a specific character;
the controller implemented with an algorithm that groups multiple children who reside in a common area, the grouping sharing a same parent; and identifies the parent as a common zone factor, wherein the common zone factor is a constant value common to all location points of a particular zone.

10. The system of claim 9, wherein the location point is obtained from over the air database.

11. The system of claim 9, wherein the location point has latitude and longitude coordinates.

12. The system of claim 9, wherein identifying the common zone factor compresses the data.

13. The system of claim 9, wherein a first set of digits of multiple digits of the coordinates determines an outer zone.

14. The system of claim 13, wherein a second set of digits of the multiple digits determines an inner zone.

15. The system of claim 14, wherein a remaining set of digits multiple digits is converted to Cartesian coordinates.

16. A method to produce data of a series of location coordinates of a motor vehicle, the method comprising:
receiving a location point on a map of the motor vehicle, each location having a latitude and a longitude coordinate, each location being treated as a child with a specific character;
grouping multiple children who reside in a common area, the grouping sharing a same parent;
identifying the parent as a common zone factor, wherein the common zone factor is a constant value common to all location points of a particular zone; and
calculating multiple digits from the location points in the common zone, a first set of digits of the multiple digits determining an outer zone; a second set of digits of the multiple digits determining an inner zone, and a remaining set of digits of the multiple digits is converted to Cartesian coordinates of the location points.

17. The method of claim 18, wherein identifying the common zone factor compresses the data to reduce storage requirements of the data by about 60% as compared to the storage requirement without the compression of the data.

18. The method of claim 18, wherein the parent-child format is compresses the location data without jeopardizing the accuracy of the original location points.

19. The method of claim 18, wherein a flexibility of choosing a range for the common zone and a number of outer and inner zones provide different applications with arbitrary accuracies and storage requirements.
